(19) United States
(12) Patent Application Publication
(10) Pub. No.: US 2010/0244451 A1
(43) Pub. Date: Sep. 30, 2010

(54) Ocean wave energy to electricity generator

(76) Inventor: Ned M. Ahdoot, Rancho Palos Verdes, CA (US)

Correspondence Address: NED M. AHDOOT, 6916 Kings Harbar Dr., Rancho Palos Verdes, CA, 90275, US

(21) Appl. No.: 12/383,808

(22) Filed: Mar. 30, 2009

(51) Int. Cl. F03B 13/18

(52) U.S. Cl. 290/53

(57) ABSTRACT

A stationary structure comprising a frame supported by an ocean surface and a subsurface buoyant body while extending above the ocean surface, the frame supporting a buoyant body floating on the ocean surface and freely riding on the frame according to the ocean wave motion. The floatation body that moves with the waves and the linear motion of the waves are translated to rotational motion to energize a generator. When the water level changes, the generator and the associated mechanical and electrical to structure is automatically adjusted to maintain the effectiveness of the system.

### CROSS-REFERENCE TO RELATED APPLICATIONS

Application Ser. No. 11/788,528

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

### Field of the Present Disclosure

This disclosure relates generally to machines for harnessing ocean wave movement to create useful work such as the generation of electricity.

Wood; Charles W. U.S. Pat. No. 7,042,112 discloses an omni-directional system configured to convert the kinetic and potential energy in ocean waves to electrical energy or in some special cases to other forms of energy such as heat, mechanical and pressure energy. The system employs a float moored by a single hydraulic cylinder anchored to the seabed. Wave energy is captured as the float is displaced vertically and horizontally in response to wave action extending the hydraulic cylinder that in turn forces fluid under high pressure to the float where appropriate valves, hydraulic accumulators, and variable displacement hydraulic motors are arranged to drive electric generators. A secondary benefit of the system is the reduction of near shore erosion.

Lee; Koo Shik U.S. Pat. No. 7,042,112 discloses 1 hydraulic power generating system designed to minimize equipment costs by simplifying the configuration thereof, to maximize efficiency of power generation by reducing loss in hydraulic power, and to allow economical and convenient maintenance of the system. The system comprises a power generator, a buoy floating the power generator on the surface of the water, and a fixing apparatus restricting movement of the buoy and the power generator. The power generator comprises a looped rail, a plurality of pulleys moving along the rail, a coupler to join the plurality of pulleys, a plurality of wings, each being installed to each of the pulleys to move the pulley by absorbing flow energy of water, and a generator installed in the rail to generate electricity after receiving kinetic energy of the pulleys through power transmission gears. The system is enhanced in its configuration, allowing economical and convenient maintenance of the hydraulic power generating system, while not being restricted as to the location where the power generator may be installed.

Yumita; Yukinobu, Kumagai; Hideo U.S. Pat. No. 7,042,111 discloses a hydraulic power generating device includes a main body case forming a flow passage provided with a water wheel chamber between a fluid inlet port and a fluid outlet port, a cover covering the main body case, a water wheel for power generation disposed in the water wheel chamber, a rotor magnet for rotating in cooperation with the water wheel. An ejection port including a groove is formed on the main body case for ejecting fluid toward the blades of the water wheel at a high speed and an protrusion part is formed on the cover for adjusting the aperture area of the ejection port by entering into the groove. Further, a discharge space is formed at a downstream position of the water wheel chamber so as to be in communication with the fluid outlet port, to which fluid after having rotated the water wheel is ejected and a stagnation preventing protrusion part is formed in the discharge space to facilitate flow of air bubbles to the fluid outlet port.

Davis; Lester U.S. Pat. No. 7,003,955 discloses an enhanced pumped storage power system. More particularly, the invention is a regenerative power system that utilizes the gravitational forces of downward movement of large quantities of water to convert same to electrical energy. In the preferred mode of implementation, the system utilizes a man-made lake at a first level of elevation. Though higher altitudes can be effective, the lake need only be approximately twenty to thirty feet in elevation. The lake, which may exceed one hundred acres in size, may be elevated above and adjacent a natural body of water, such as seawater at a coastline. As such, sandy terrain associated with the region facilitates initial construction of the system. An underground generator is utilized for the power conversion and pumping of the water back to the upper reservoir during times of low energy demand, allowing for significant noise reduction. Importantly, the system of the present invention may be utilized to provide significant levels of power to serve relatively large geographic areas during times of peak energy demand, when other sources of power are more expensive and subject to power outages. Finally, it should be noted that the components of the system are aesthetically-pleasing in nature, allowing the system to be effectively utilized in a residential area.

Cousins; Edward Thomas U.S. Pat. No. 7,002,261 discloses a method and apparatus is described for a downhole submersible electrical power generator. The electrical power generator includes a housing forming a fluid conduit. An inlet is disposed on the housing. Also, an outlet is disposed on the housing where the inlet and the outlet are adapted to allow a fluid to flow into and out of the housing, respectively. A fluid flow powered electrical power generator is disposed inside the housing and is adapted to generate electrical power from the fluid flowing through the housing. An isolation packer is disposed outside the housing between the inlet and the outlet where the isolation packer is adapted to isolate the inlet and the outlet in different zones in a wellbore.

Serrano Molina; Jose Antonio (Barcelona, ES); Serrano Cabello; Jose Antonio (Barcelona, ES); Arcos Montes; Juan Manuel (Montcada I Reixac, ES); Puerta Sardo; Ferran Josep (Terrasa, ES); Garcia-Calvillo Miralles; Manuel Antonio (Esparreguera, ES); Lopez Huete; Jose Doroteo (L'Hospitalet de Llobregat, ES) U.S. Pat. No. 6,956,299 Includes at least one floating body (1), and is characterised in that includes a device (2) fitted inside said body (1) for transforming the movement of the floating body (1) into pneumatic or hydraulic energy and means for transmitting the energy to dry land or to a fixed structure. An energy-generation system is obtained thereby with a manufacturing time and cost lower than the systems currently known. Moreover, the fact that the transforming device (2) is fitted inside the floating body (1) means that it is protected against corrosion caused by the water, against sharp movements caused by marine currents and against other possible outside agents which might harm or damage any of the components which make up the device.

Krouse; Wayne F. U.S. Pat. No. 6,955,049 discloses a machine and system for power generation through movement of water having an array of power generating cells electrically interconnected, where the array is configured in an interchangeable modular fashion and the cells are positioned to receive kinetic energy from the movement of water to generate electricity through the movement of an electrical generator within each cell. The individual generators and cells may generate relatively small amounts of electricity and use polymer magnetics in the impellers and windings in the generator to withstand ocean environments and are stacked on electrically conductive trays for ease of installation and replacement.

Aukon; Dennis W. U.S. Pat. No. 7,042,113 discloses a hydroelectric generator having a fixed axle, at least one transmission axle parallel to the fixed axle, and a transmission system configured to rotate the transmission axle about the fixed axle and to apply a force to at least one driven member of a device for generating electricity.

Atiya Ramez U.S. Pat. No. 6,967,413 discloses the Tidal Energy System is a structure capable of extracting energy from the potential and kinetic energies of the tides, as well as from ocean waves and offshore wind. Its components operate synergistically in multiple capacities to extract energy from these sources so that the Tidal Energy System operates as unit. The Tidal Energy System is structured so that it can be operated integrally with electrolyzer and fuel cell technology to produce on demand power thus eliminating the pulse character of conventional tidal power. The Tidal Energy System can also generate hydrogen as an end product.

Keneth W Welch U.S. Pat. No. 6,953,328 B2 discloses a buoyancy pump device for use in fluid. The buoyancy pump device includes a buoyancy block housing defining a buoyancy chamber therein through which the fluid may flow. A buoyancy block is disposed within the buoyancy chamber to move axially therein in a first direction responsive to rising of the fluid in the buoyancy chamber and a second direction responsive to lowering of the fluid in the buoyancy chamber. A piston cylinder is connected to the buoyancy block housing and has at least one valve disposed therein operating as an inlet in response to movement of the buoyancy block in the second direction and an outlet in response to movement of the buoyancy block in the first direction. A piston is slideably disposed within the piston cylinder and connected to the buoyancy block, the piston being moveable in the first and second directions and responsive to movement of the buoyancy block in the second direction to draw a gas or liquid substance into the piston cylinder through the at least one valve, and responsive to movement of the buoyancy block in the first direction to output the gas or liquid substance through the at least one valve.

Conn et al., U.S. Pat. No. 4,034,231 discloses a machine for harnessing the motion of ocean waves in order to convert the motion energy into useful electrical power; the machine consists of a large V-shaped frame, submerged near a beach, having its apex pointed away from the beach, and the frame supporting a series of water generators connected to an electric generator so that incoming waves toward a beach move along the outer side of the frame while turning the generator rotors, and outgoing waves moving along the inner side of the frame turn the generator rotors.

Ootsu, U.S. Pat. No. 4,071,305 discloses a set of aligned transducer units that are fixedly disposed in the sea. Each unit includes two atmosphere compartments on the opposite end portions so that a sea water stream created by tidal current flowing through its lower portion, between the compartments, drives an impeller disposed between the compartments. The sea water stream rotating the impeller actuates air cylinders disposed in both atmosphere compartments communicating with the atmosphere. The air cylinders compress the air to produce high pressure air. This high pressure air from all the cylinders is transported through a common pipe to an adjacent shore where it may be converted into electrical energy. A ballast water room with its control is connected to the underside of the transducer set for floating and sinking the apparatus.

Rainey, U.S. Pat. No. 4,208,878 discloses a tide motor energy source which includes a tidal piston with a valved chamber. The piston drives a hydraulic ram to generate electrical power through a pressure accumulator and hydraulic motor. The ram can be locked hydraulically to enable the tidal piston to be held fixed at a desired elevation. The valves in the chamber permit it to be filled with water or air. The piston with its chamber filled with air at its low tide position and then released for controlled ascent, while submerged, acts as a submerged float for driving the ram upwardly while the tide runs in during one phase of its operation. The piston with its chamber filled with water, while locked at its highest position as the tide begins to run out, and then released to fall under control, acts as a weight suspended in air after the water level drops below the piston for driving the ram downwardly during the second phase of its operation. The rising and falling motion of the tidal piston is used as the energy source.

Scott, U.S. Pat. No. 4,418,286 discloses an electric generator system which is wave and/or tidal driven and includes energy storage means to allow a constant electrical output to be realized. The above is accomplished through a counterbalanced walking beam which is wave driven. This beam is connected to one way ratchet drives and an interconnected spring system of varying torque capacities. A governor is connected to the spring system thereby allowing the generator to be driven at a constant speed.

Masubuchi, U.S. Pat. No. 4,464,578 discloses a wave energy converter comprising a float group including at least two floats connected by elongated rigid links disposed at a right angle to the direction of incidence of waves, of which floats are free from the coastal ground and sea bed, and allowed to heave, to sway, and to roll. A dynamic system of the converter absorbs the wave energy through the relative movements between the floats and the links, and between the adjacent links while the natural frequency of this system is approximately tuned to the frequency of the incident wave. In this way, the reflected waves and transmitted waves caused by this system are suppressed substantially since the energy of the incident wave is virtually absorbed. The wave energy converter may be provided with some air chambers and air generators or one-directional rotating means actuated by this dynamic system, so as to drive electric generators coupled thereto.

French, U.S. Pat. No. 4,495,765 discloses an invention providing a device for converting wave energy into useful work, and comprises a body adapted to be moved to and fro by waves on a liquid, and means such as a hydraulic piston in a cylinder for converting this movement of the body into a power output. The body may be disposed about a horizontal cable along which the to and fro movement of the body is arranged to occur, the cable being secured to the piston so that relative movement between the body and the cable results in displacement of the piston in the cylinder. A plurality of cables may be threaded through the body, and some of these cables may be in mutually perpendicular relationship to each other to provide a device having an omnidirectional wave energy conversion capability.

Choi, U.S. Pat. No. 4,544,849 discloses an invention relating to a method and apparatus for tidal electric power generation using the buoyancy energy of the tide. The present invention includes a buoyant container having a balancing buoyant room and a flood gate, a power transmission apparatus having a converting apparatus, and a four-way valve. The buoyancy force of the buoyant container is decreased during the upward movement of the container, while the kinetic energy decreases during the downward movement of the container. With control of the four-way valve, the decreasing buoyancy force is partially compensated for by the pumping of water from the buoyant container and the kinetic energy is reinforced by filling the buoyant container with water. The converting apparatus comprises two conic helical gears. By using the conic helical gear, the buoyancy force and the kinetic energy are constantly transmitted into the pump. Particularly, this invention contains a brake which holds the buoyant container at a height where the weight of the buoyant container balances with the buoyancy force. At the ebb and flow of the tide, the brake is released and instantaneous force is produced. By virtue of the present invention, the greater energy can be obtained with little energy loss compared with the conventional manner.

Koruthu, U.S. Pat. No. 4,598,211 discloses a float/weights that are positioned in tidal water, arranged to rise and fall with the tides. A power unit including a cylinder and piston is arranged with the piston, connected with the float/weights, and draws water into it upon the float/weights rising and forcing it into a storage unit upon the float/weights dropping. The storage unit includes a cylinder and a weighted piston. After the storage unit is filled, the water is let out to drive a water generator and generator. The apparatus may use a closed circuit for the water, or an open circuit and draw it directly from the sea, and return it to the sea. In the use of a closed circuit, instead of sea water, the apparatus may use fresh water, or oil. The apparatus is also adapted to use compressed gas instead of liquid.

Ames, U.S. Pat. No. 4,672,222 discloses a self-stabilized and modularly expandable system of independently operative point absorbers with respective drive transmissions and electrical generators which produce electricity from wave motion on a body of water.

Vides, U.S. Pat. No. 4,718,231 discloses an assembly comprised of an elongated float member which floats on the surface of a body of water, having waves moving therealong. A support arm freely and pivotally connects to the float member for maintaining the float member parallel to the surface of the water. The support arm member is effective to maintain the float member with its longest dimension disposed in a direction parallel to the length of the waves moving along the surface of the body of water. A transmission assembly is responsive to the support arm member as the float member moves up and down with the movement of the waves to produce a rotational movement in a transmission shaft from which energy may be derived. Various features directed to the specific configuration of the float member, support arm member, transmission mechanism, including the structure of a transmission shaft and a clutch mechanism, are also disclosed.

Pedersen, U.S. Pat. No. 4,864,152 discloses a floating water current power station comprising a ring-shaped pontoon, which by means of a mooring bit is anchored to anchors. All generators are detachably arranged on a common beam and can, as a unit, be swung up to the surface within the area limited by the ring pontoon. The power station may swing around the bit, the upper end of which is connected to a front pontoon, and a lower end of which is secured to the anchors, and which is moreover provided with tension distributing warps to the generator beam; and warps to the same pontoon side as the one to which the bit is secured.

Marino, U.S. Pat. No. 5,184,915 discloses an apparatus for lifting up water to a predetermined level where it can be useful, using the inexhaustible and non-polluting source of energy of the ocean tides to do so. The apparatus comprises a water chamber positioned to be filled with water following a rise in tide. Rising on the tide causes some air to be trapped and pressurized on top of the chamber. This pressurized air in turn is used to push some water up to the predetermined level.

William Walter Hirsch, U.S. Pat. No. 7,199,481 B2 Wave Energy Conversion System.

Frank Burick U.S. Pat. No. 7,365,445B2 Apparatus for converting ocean wave energy to electrical energy.

Stephen J. Sadig U.S. Pat. No. 6,812,588B1 Wave Energy Converter.

Fred Ernest Gardener U.S. Pat. No. 5,909,060 Wave Energy Transformer

Dreck Woollatt U.S. Pat. No. 5,647,730 Self-Contained Clearance Volume Adjustment Means for a Gas Compressor.

Tzong et el U.S. Pat. No. 5,186,822 Wave Powered Desalinization With Turbine Driven Pressurization.

Ernest p. Rubi U.S. Pat. No. 4,851,704 Wave Action Electricity Generation System and Method.

Don E Rainey U.S. Pat. No. 4,208,878 Ocean Tide Energy Converter.

The related art described above discloses apparatus and methods for converting water motion and weight to useful energy. However, the prior art fails to disclose the presently described energy generating capability to adapt to tidal ocean levels and to wave heights. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

A buoyant body connected to a shaft for moving and directing linear motions caused by ocean waves; a rack and pinion gear box device causing the linear motions of the first and second shaft to axial rotational motions, the rotation of the second and third shaft in only one direction; a ratchet wheel connected to the third shaft and a electric generator.

A body connected to a stationary platform on one side and connected to a buoyant body with a rope, a rack and pinion gear box device causing the linear motions of the rope to axial rotational motions, the rotation of the second shaft in only one direction; a ratchet wheel connected to the second shaft and a electric generator.

A primary objective inherent in the above described apparatus and method of use is to provide advantages not taught by the prior art.

Another objective is to provide a wave motion detection adaptive to tidal levels and maintaining a constant rotational speed for driving a generator or performing other useful work.

A still further objective is to provide such a system that is fully automated in its operation.

A yet further objective is to provide such a system that also uses water momentum giving rise to lateral forces for driving pumps.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is the embodiment of the converter to be deployed anywhere in the ocean.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

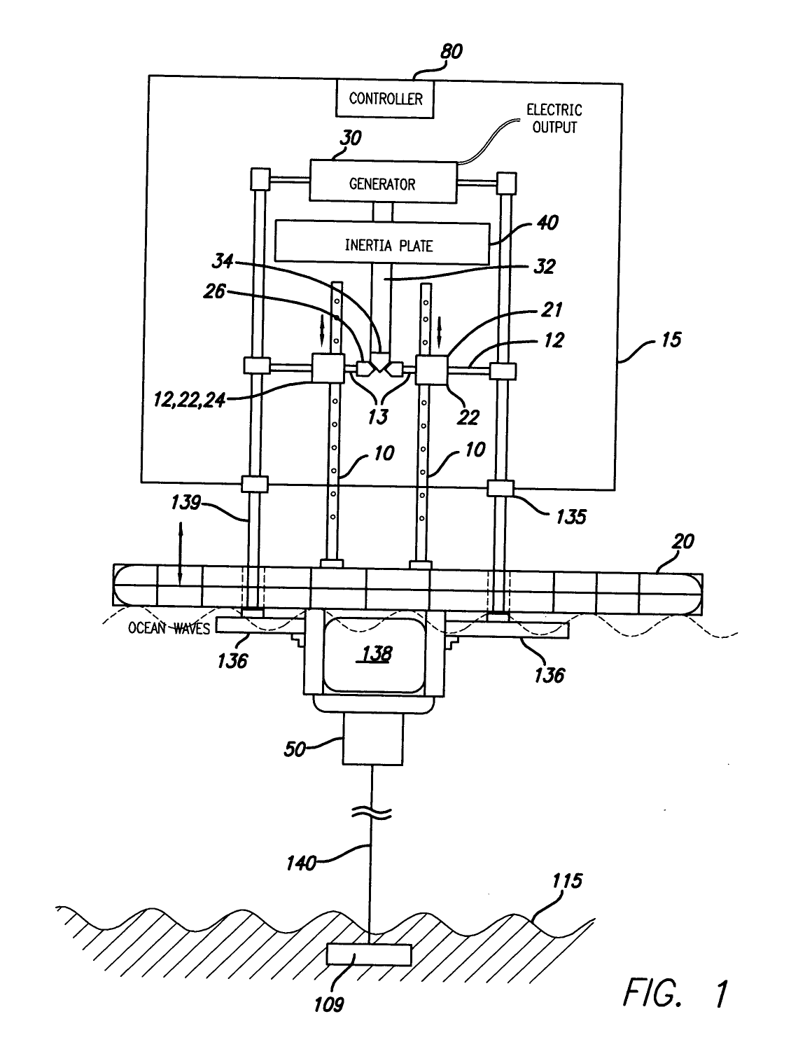

Described now in detail, in a first embodiment shown in FIG. 1 comprising the frame 15 that is supported by an ocean surface and subsurface buoyant body 136 comprising of an air bag 138, and the frame being held in a vertical position above the ocean floor by a rope anchored to the ground 109. Extending from the buoyant body are poles 139 supporting the frame 15 and a raft 20. The raft moves up and down with respect to the buoyant body and guided by the poles 139. A first shaft 10 is constrained for moving with linear motion in a vertical direction, the first shaft 10 is engaged with buoyant body 20 so that wave motion is able to displace shaft 10. A second, horizontally oriented shaft 12 is constrained for rotational motion caused by linear motions of 10. A rack 21 and a pinion 22 are engaged with the second shaft 12 and the third shaft 13 respectfully, and are mutually engaged so that the linear motion of the shaft 10 drives rotational motion of the third shaft 13. The pinion 22 is mounted on a ratchet wheel so that force is transferred from the first shaft 10 to the third shaft 13 only when the first shaft 10 is moving upward. When the shaft 10 moves downward, the rack 21 still turns the pinion 22, but the ratchet wheel disengages the pinion 22 from the third shaft 13. The ratchet wheel operates in the same manner as a coaster gear of a bicycle chain drive where, when the drive chain rotates the bicycle's drive sprocket in a direction for moving the bicycle forward, the drive sprocket transfers driving force to the bicycle's rear axle through the coaster gear, but when the chain stops moving, or even moves backward, the coaster gear disengages the drive sprocket from the bicycle's axle. This technique is very well known in the art.

A forth shaft 32, that of an electric generator 30, is engaged with the second shaft 13 through mutually meshed bevel gears 34 and 26 respectively. The third shaft 32 drives an inertial plate 40 and the generator 30 to produce electrical energy directly which is therefore available for transfer to an electrical load by power cables with proper terminations as transmission lines as is well known in the electrical engineering art.

It should be clear to those of skill in the art, that by applying further gear interfaces positioned on opposing sides of each shaft, it is possible to harness both upward as well as downward motions of buoyant body 20 in driving shaft 30 in its preferred sense of rotation.

Referring aging to FIG. 1, the frame 15 and 136 is adapted to get adjusted for at least one of the ocean tidal and wave levels by controller 80, a pressure transducer, a motor 50, and the rope 140. The momentary pressure data from the transducer is transferred to the controller and the controller makes decisions to adjusts the length of the rope by activating the motor.

It should be clear to those of skill in the art, that by using the available geographical tidal charts and data, the controller can use this data to control the length of the rope.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An electricity generating apparatus comprising: a first shaft constrained for moving with linear axial motion; a second shaft constrained for moving with rotational motion; a rack and pinion engaging the first and second shafts respectively so that the linear motion of the first shaft drives rotational motion of the second shaft; the pinion mounted on a ratchet wheel thereby being driven by the rack during linear displacement of the first shaft in one direction only; a third shaft engaged with the second shaft through mutually meshed bevel gears; the third shaft coaxially connected to a flywheel engaged with a generator, thereby producing rotation of the generator when the first shaft moves with reciprocating motion.

2. The apparatus of claim 1 further comprising a frame supported by one of: an ocean surface and a subsurface buoyant body while extending above the ocean surface, the frame supporting a buoyant body floating on the ocean surface and freely riding vertically on the frame according to the ocean wave motion, the buoyant body joined with the first shaft for enabling reciprocating motion of the first shaft according to ocean wave motion.

3. The apparatus of claim 1 further providing a control system adapted to adjust the position of the frame vertically for at least one of wave height and tidal variations.

4. The apparatus of claim 1 further comprising a frame mounted on an ocean floor, a buoyant body floating on a corresponding ocean surface above the frame and freely riding vertically thereon according to ocean wave motion; the buoyant body interconnected with the first shaft enabling reciprocating motion of the first shaft according to ocean wave motion.
